(19) United States
(12) Patent Application Publication
(10) Pub. No.: US 2024/0426616 A1
(43) Pub. Date: Dec. 26, 2024

(54) CURBSIDE STOP ROUTING IN A FLEET ROUTING SYSTEM

(71) Applicant: ZUM SERVICES, INC., Radwood City, CA (US)

(72) Inventors: Himanshu Arora, Redwood City, CA (US); Rashmi Choudhary, Redwood City, CA (US); Abhishek Garg, Redwood City, CA (US); Kanstantsin Gerasimovich, Redwood City, CA (US); Rohit Jain, Redwood City, CA (US); Andrew Mormysh, Redwood City, CA (US); Shiva Nagabushanaswamy, Redwood City, CA (US)

(73) Assignee: ZUM SERVICES, INC., Redwood City, CA (US)

(21) Appl. No.: 18/212,589

(22) Filed: Jun. 21, 2023

(51) Int. Cl. G01C 21/34

(52) U.S. Cl. CPC G01C 21/343; G01C 21/3453; G06Q 10/047; G06Q 50/40

(57) ABSTRACT

A system and method include a server device which identifies a plurality of stops for a vehicle among a fleet of vehicles. The server device also identifies stop locations for each one of the plurality of stops and a side of a street for each one of the plurality of stops. Once identified, the server devices generates an optimized route for service by the vehicle to service each one of the stop based on an optimized stop order for each one of the plurality of stops based on the stop locations being disposed only on the identified side of the street for each one of the plurality of stop locations. The optimized route may be provided to a driver device while the route and time of arrival information may be provided to a user.

### TECHNICAL FIELD

The present application discloses a system for routing a fleet of vehicles, scheduling stops, and optimizing those routes and stops based on one or more elements of primary concern. In particular, the present application teaches a system provides navigation for vehicles, such as buses, to conduct a drop off on a side of the road where the drop off is to occur such that a child or a driver does not have to cross the road to be picked up or arrive at their destination.

### BACKGROUND

The earliest advent of a fleet of vehicles likely dates back to antiquity when vehicles became necessary for the transport of people and goods. Fleets of boats are known to have existed in ancient Greece while fleets of chariots were known to have been used in ancient wars both as vehicles of war and as transport vehicles for soldiers and supplies. Even horses themselves have been used for the purpose of transporting people and goods. Indeed, many ancient stories of certain battles turn on the use of fleets of vehicles and their relative coordination in both timing and goals to the win or loss of a battle.

In the more recent past, trains, sail powered boats, and ocean liners were assembled into fleets for both military and civilian use. Since trips across continents or across oceans were typically of an extended duration, schedules and stops for these vehicles, especially in the context of civilian use, were published well in advance of an actual date of embarkation. These dates and schedules were largely accurate given the need to be at a next stop or location in a certain amount of time. Many ocean liners, for example, stopped in multiple ports to pick up passengers and goods before transporting both across the ocean. Trains kept a specific schedule on a time duration basis. For example, a train may leave from Paris for Berlin every other day allowing time for a day to make the trip from Paris to Berlin and a day to make the trip back. At the same time, other trains may have traveled from Trenton, New Jersey to New York City, New York several times per day. Historically, these schedules were based on the number of vehicles available and on the travel time necessary for trips between stops.

The advent of the modern automobile changed transportation all across the world on seemingly an overnight basis, at least in retrospect. Motorized land based transportation without the aid of rails made automobiles the transport method of choice for anything that was not too heavy or far away. Trucks could easily carry people and goods over short distances with very little notice, which was a major development for transportation. Buses became the vehicle of choice for transporting people as buses were fitted with seats for people. Trucks became the vehicle of choice for transporting goods from one place to another. As the relative prices of automobiles decreased and World Wars broke out, automobile fleets came into existence. Fleets of buses took passengers to places where rails did not exist while fleets of trucks took goods from boats in the harbor to soldiers fighting inland.

Fleet logistics became an issue of major importance to military and civilian fleet owners alike. It became imperative to ensure that certain vehicles were available for certain transportation tasks on a periodic basis, whether that basis was a multiple times per day basis, a day to day basis, a weekly basis, or some other periodic basis. Automobiles became different from fleet vehicles such as trains, boats, and other ocean going vessels because automobiles could schedule multiple trips per day while making repeated visits to a logistical hub or supply center. The pace at which trucks could supply goods outstripped anything that was previously known to human civilization and made the delivery of goods possible at scale. Buses developed scheduled times and routes for conveying passengers along certain routes at certain times.

Today, massive fleets of vehicles are owned by both governmental and private institutions to facilitate the transport of goods and passengers, which is a major logistics endeavor. Fleet vehicles may have routes which are traveled on a periodic basis to serve customers in various capacities. For example, mail is delivered to virtually every home in the United States on a daily basis by mail carriers in individual trucks. Other private mail or companies and goods delivery companies also have fleets of trucks to provide mail service for individual customers. Similarly, local governmental entities operate bus lines for mass transit of passengers, typically in and out of big cities. Public bus lines, for example, use main routes with spurs that serve residential areas of a city to facilitate passengers traveling into and out from the city on a daily basis. Both public and private schools operate bus lines to safely transport children to and from school on a daily basis. School buses, however, usually operate based on stopping at certain places at certain times to safely load children to attend local schools and, for that reason, travel routes that are based on where children live, generally speaking.

Logistics for these fleets are incredibly complex, which has been a persistent problem since antiquity. Horse cavalry attacking at the wrong time on an ancient Greek battlefield and buses arriving off schedule are different implementations of the same problem spread thousands of years apart. Maintenance, location, routing, fueling, and driver support are also considerations for fleet vehicles in order to deliver passengers or goods to a particular place by a particular time. In the context of school buses, a bus may be late because of a breakdown, construction delays, fuel problems, or a missing driver which may cause a child to be late for school. Further, school buses may serve redundant routes, which could be accommodated by a single bus, which increases the relative costs of providing bus services on virtually a daily basis. Those costs may include pollution due to emissions, fuel costs, driver costs, costs in time, and others. Current solutions are not only inefficient but wasteful and contribute to cumulative emissions based environmental harm. Optimization is needed to reduce financial, pollution, and time costs in fleet vehicle use and routing.

It is, therefore, one object of this disclosure to provide a user interface that facilitates a routing system which optimizes routes for fleet vehicles. It is another object of this disclosure to provide a system that tracks elements or characteristics of a particular ride for ride security, correct ridership (or goods) and communicates those elements to different users for monitoring and prediction purposes.

### SUMMARY OF THE DISCLOSURE

A system includes a server device which identifies a plurality of stops for a vehicle among a fleet of vehicles. The server device also identifies stop locations for each one of the plurality of stops and a side of a street for each one of the plurality of stops. Once identified, the server devices generates an optimized route for service by the vehicle to service each one of the stop based on an optimized stop order for each one of the plurality of stops based on the stop locations being disposed only on the identified side of the street for each one of the plurality of stop locations. The optimized route may be provided to a driver device while the route and time of arrival information may be provided to a user.

A method is executed by a server device which identifies a plurality of stops for a vehicle among a fleet of vehicles. The server device also identifies stop locations for each one of the plurality of stops and a side of a street for each one of the plurality of stops. Once identified, the server device generates an optimized route for service by the vehicle to service each one of the stops based on an optimized stop order for each one of the plurality of stops based on the stop locations being disposed only on the identified side of the street for each one of the plurality of stop locations. The optimized route may be provided to a driver device while the route and time of arrival information may be provided to a user.

### BRIEF DESCRIPTION OF THE DRAWINGS

Non-limiting and non-exhaustive implementations of the disclosure are described with reference to the following figures, wherein like reference numerals refer to like parts throughout the various views unless otherwise specified. Advantages of the disclosure will become better understood with regard to the following description and accompanying drawings where:

FIG. 1 illustrates box diagram of a fleet routing system.

FIG. 2 illustrates an exemplary prior art interface for routing a vehicle to a destination.

FIG. 3 illustrates an exemplary user interface for a curbside pickup or drop off in a fleet routing system.

FIG. 4 illustrates an exemplary schematic implementation of an intersection of curbside routing in a fleet routing system.

FIG. 5 illustrates another embodiment of an exemplary schematic implementation of curbside routing in a fleet routing system.

FIG. 6 illustrates a schematic embodiment of optimizing routes based on an optimized stop order for a fleet routing system.

FIG. 7 illustrates a method of optimizing routes based on an optimized stop order for curbside routing in a fleet routing system.

### DETAILED DESCRIPTION

The disclosure extends to vehicles of all types which are assembled into a fleet for a common purpose or goal such as, but not limited to, delivering passengers, delivering goods, or any other purpose.

In the following description of the disclosure, reference is made to the accompanying drawings, which form a part hereof, and in which are shown by way of illustration specific implementations in which the disclosure is may be practiced. It is understood that other implementations may be utilized, and structural changes may be made without departing from the scope of the disclosure.

In the following description, for purposes of explanation and not limitation, specific techniques and embodiments are set forth, such as particular techniques and configurations, in order to provide a thorough understanding of the device disclosed herein. While the techniques and embodiments will primarily be described in context with the accompanying drawings, those skilled in the art will further appreciate that the techniques and embodiments may also be practiced in other similar devices.

Reference will now be made in detail to the exemplary embodiments, examples of which are illustrated in the accompanying drawings. Wherever possible, the same reference numbers are used throughout the drawings to refer to the same or like parts. It is further noted that elements disclosed with respect to particular embodiments are not restricted to only those embodiments in which they are described. For example, an element described in reference to one embodiment or figure, may be alternatively included in another embodiment or figure regardless of whether or not those elements are shown or described in another embodiment or figure. In other words, elements in the figures may be interchangeable between various embodiments disclosed herein, whether shown or not.

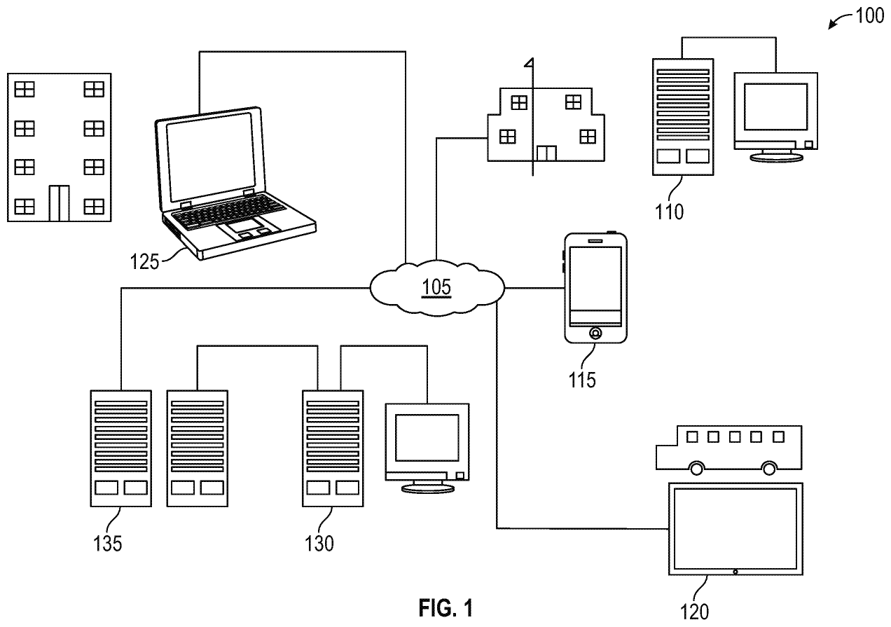

FIG. 1 illustrates a box diagram of a fleet routing system 100. Fleet routing system may be implemented by use of a communications network 105 such as the Internet, which facilitates the exchange of information between various devices within fleet routing system 100. Fleet routing system may be used with any fleet but is described with respect to a fleet of school buses. The techniques disclosed herein may be used to deliver passengers or goods with little or no modification. Fleet routing system 100 may be implemented between a ride requestor device, such as a school device 110 (and/or an administration level device 125, which will be discussed below) and a user device 115, and a driver device 120 associated with a bus driver, for example. Fleet routing system 100 may be implemented by an administrator device 125. A provider may provide the administrator device 125 or the ride requestor device 110 with access to fleet routing system 100 by use of servers 135 and provider device 130. In one implementation, a school district may use administration level device 125 which provides buses to pick up and deliver children to a school and operate in a manner similar to ride requestor device 110. In other embodiments, ride requestor device 110 may be implemented to schedule routing for bus routes for a particular school. In other words, various levels of administration may access and implement fleet routing system 100 according to their particular needs for the delivery of passengers.

At the outset, a provider device 130 may give a ride requestor device 110 or an administrator level device 125 access to fleet routing system 100 by servers 135 to create bus routing for a particular school district or school as appropriate. Servers 135 may provide a user interface to ride requestor device 110 or an administrator level device 125 to create routes for each child in the district or school as appropriate. For example, a profile may be created for each child in the district or school as appropriate to be stored in non-volatile non-transitory storage media, which includes a home address for each child. In response, fleet routing system 100 may determine a distance between identified stops and a travel time between each of those identified stops to determine both a single bus route and a number of buses required for a necessary number of routes. For example, based on a standard bus configuration, a school bus may transport 80 seated students. However, due to time and distance constraints, a certain bus may only be able to pick up 45 students at identified stops. The identified stops may be based on ensuring a child does not cross a road or lives within a certain distance of the identified stop. If one location is heavily populated with children who need to board a school bus, optimized routing may determine that since more children are boarding per identified stop, that particular school bus may need less time to complete an assigned route. In one embodiment, fleet routing system 100 may optimize routes based on the shortest time on the road for each bus, based on minimal fuel usage across the fleet, based on minimal emissions across the fleet, based on or any other basis that is meaningful to the school or community served by the school.

Once the routes are generated with children assigned to a particular bus, server 135 may transmit bus information to user device 115 by fleet routing system 100. Bus information may include bus stop information for picking up a child and a time for pick up at the bus stop. User device 115 may be associated with the child bus rider or with a parent of the child bus rider. User device 115 may be implemented as separate devices where one device is associated with the child rider and another device is associated with a parent, guardian, or other supervisor of a child. When the school bus is operating, a real time location may be provided to user device 115 so that the child and child supervisor may identify where the bus is currently located. A child or child supervisor may use user device 115 to create the child profile discussed above by providing information from user device 115 through communications network 105 to server 135.

Further, once the routes are generated, server 135 may transmit individual route information to a bus driver via driver device 120, in fleet routing system 100. Individual route information may be a mandatory bus route for the driver to follow with a stop sequence that is identified along the individual route. Individual route information may include turn by turn instructions with expected drive time duration and distance for the bus driver. Driver device 120 may also detect information from a particular bus drive and provide that information to server 135 through communication network 135. Information provided from driver device 120 may include distance traveled information, fuel use information, pickup duration information, bus stop location information (e.g., information about where the stop is designated versus where the stop actually occurred), speed of travel information (in terms of actual speeding and in terms of slowdowns caused by traffic, construction, or any other road condition), rider verification information, rider disembarking information, and any other information that may be used by server 135 to optimize routing. In one embodiment, driver device 120 may receive an optimized route from server 135 for picking up children based on a home or a school address and/or prior pickup/drop off history locations for children on a particular route. In another embodiment, driver device 120 may further be optimized to prevent U-turns, enforce curbside pickup to avoid children crossing streets. Server 135 may receive information from driver device 120 which it may use to optimize routes based on learning from past driver routes to determine a best path between stops. Server 135 may receive information from driver device 120 which may optimize based on learned roadblocks and driver input to driver device 120 with new information (e.g., a street closure or construction) which causes server 135 to reoptimize the bus route. Server 135 may use information to determine and store driving instructions at the ride route level for a particular bus and driver device 120. Server 135 may track a bus via driver device 135 during a pickup or drop off ride and ensure compliance with the optimized route. If driver device 120 indicates that a bus is not following optimized route information, server 135 may send a message to ride requestor device 110, administrator device 125, or provider device 130 to allow either the ride requestor, the administrator, or the provider to contact the bus driver with route correction instructions.

Based on information received from driver device 120, server device 135 may maintain estimated global positioning system (“GPS”) waypoints and an estimated time of arrival (“ETA”) information for each ride, which may be constantly updated based on information provided by driver device 120. Driver device 120 may further provide real time routing, navigation, and path information based on a current location of driver device 120. Routing, navigation, and path information may be displayed on a screen associated with driver device 120. The user may receive, via user device 115, expected vehicle path information on a map displayed on a screen of user device 115. Thus, a user of user device 115 may be able to track bus 120 in real time and observe where a bus is currently and when a bus will be at a specific stop, which may be identified by waypoints provided to the user from server 135 via user device 115. Any data received from driver device 120 may be stored as historical data which may be used to further optimize bus routing on a permanent or temporary basis depending on road conditions, pickup/drop off requirements, and any other factor identified herein.

Ride requestor device 110, user device 115, driver device 120, administrator device 125, and provider device 130 may be implemented as any electronic device with processing power sufficient to share electronic information back and forth through communications network 105. Examples of ride requestor device 110, user device 115, driver device 120, administrator device 125, and provider device 130 include mobile phones, desktop computers, laptop computers, tablets, game consoles, personal computers, mobile devices, notebook computers, smart watches, and any other digital device that has the processing ability to interact with server 135.

Ride requestor device 110, user device 115, driver device 120, administrator device 125, and provider device 130 may include software and hardware modules that execute computer operations, communicate with communication networks 105 and server 135. Further, hardware components may include a combination of Central Processing Units (“CPUs”), buses, volatile and non-volatile memory devices, storage units, non-transitory computer-readable storage media, data processors, processing devices, control devices transmitters, receivers, antennas, transceivers, input devices, output devices, network interface devices, and other types of components that are apparent to those skilled in the art. These hardware components within ride requestor device 110, user device 115, driver device 120, administrator device 125, and provider device 130, are used to connect with server 135.

Server 135 may provide web-based access to fleet routing system 100 (or relevant portions based on which device is associated with a particular function—e.g., a parent using user device 115 may not have permissions to reroute buses) to ride requestor device 110, user device 115, driver device 120, administrator device 125, and provider device 130. Communication network 105 may be a wired, wireless, or both and facilitate communications in fleet routing system 100. Server 135 may include cloud computers, super computers, mainframe computers, application servers, catalog servers, communications servers, computing servers, database servers, file servers, game servers, home servers, proxy servers, stand-alone servers, web servers, combinations of one or more of the foregoing examples, and any other computing device that may be used to execute optimized routing and communication for web based fleet routing system 100. Server computer 135 may be implemented as one or more actual devices but are collectively referred to as server computer 135 may include software and hardware modules, sequences of instructions, routines, data structures, display interfaces, and other types of structures that execute server computer operations. Further, hardware components may include a combination of Central Processing Units (“CPUs”), buses, volatile and non-volatile memory devices, storage units, non-transitory computer-readable storage media, data processors, processing devices, processors, control devices transmitters, receivers, antennas, transceivers, input devices, output devices, network interface devices, and other types of components that are apparent to those skilled in the art. These hardware components within one or more server 135 may be used to execute the various methods or algorithms disclosed herein, and interface with ride requestor device 110, user device 115, driver device 120, administrator device 125, and provider device 130.

In one embodiment, ride requestor device 110, user device 115, driver device 120, administrator device 125, and provider device 130 may access server 135 by a communication network 105. In each case, wireless communication network 135 connects ride requestor device 110, user device 115, driver device 120, administrator device 125, and provider device 130 via an internet connection provided by communication network 105. Any suitable internet connection may be implemented for wireless communication network 105 including any wired, wireless, or cellular based connections. Examples of these various internet connections include implementations using Wi-Fi, ZigBee, Z-Wave, RF4CE, Ethernet, telephone line, cellular channels, or others that operate in accordance with protocols defined in IEEE (Institute of Electrical and Electronics Engineers) 802.11, 801.11a, 801.11b, 801.11e, 802.11g, 802.11h, 802.11i, 802.11n, 802.16, 802.16d, 802.16e, or 802.16m using any network type including a wide-area network (“WAN”), a local-area network (“LAN”), a 2G network, a 3G network, a 4G network, a 5G network and its successors, a Worldwide Interoperability for Microwave Access (WiMAX) network, a Long Term Evolution (LTE) network, Code-Division Multiple Access (CDMA) network, Wideband CDMA (WCDMA) network, any type of satellite or cellular network, or any other appropriate protocol to facilitate communication between, ride requestor device 110, user device 115, driver device 120, administrator device 125, and provider device 130 and server 135.

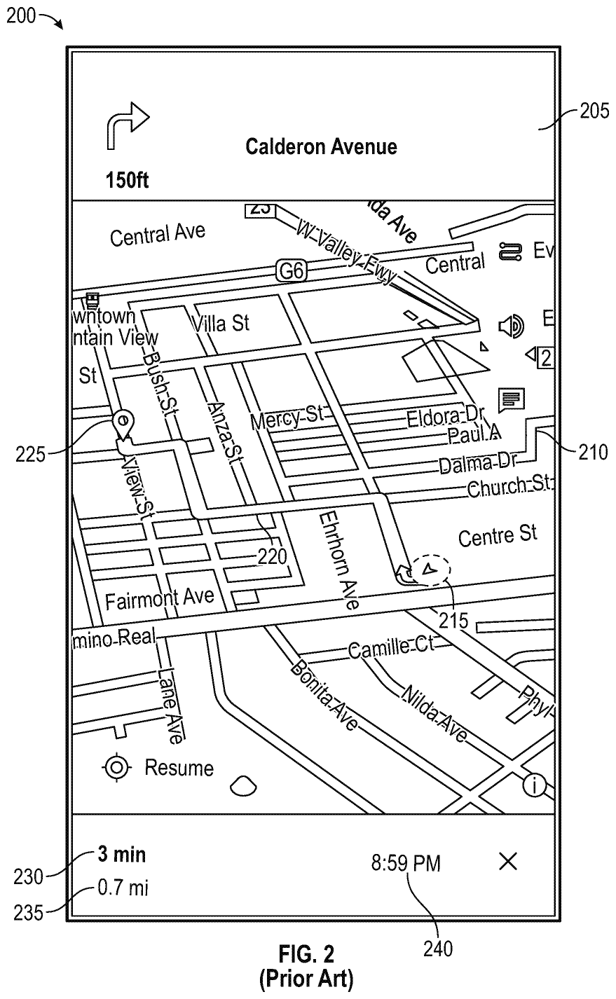

FIG. 2 illustrates an exemplary prior art interface 200 for routing a vehicle to a destination. FIG. 2 will be explained with reference to a bus, which has a passenger door disposed on a “curb” side of a bus. Said another way, the passenger door on a bus opens to allow users to embark or disembark from a side of the bus that faces a curb. In the United States, from the position of sitting on the bus, the “curb” side of the bus would be to the user or driver's right side. Interface 200 illustrates a turn by turn routing interface 205, and a map 210. Map 210 illustrates a point 215 on route 220. Point 215 is illustrated as a current location point represented on the map. Route 220 extends from point 215 to destination 225. Map 210 illustrates, in conjunction with turn by turn routing interface, a series of directions to arrive at destination 225. From point 215, a driver may turn right on Calderon Avenue, and proceed to Church Street. At Church Street, the driver may turn left to Bush Street and proceed along Mercy Street to View Street. At View Street, the driver may turn the vehicle onto View Street and drive to destination 225.

However, destination 225 is a location that positions the vehicle on the wrong side of a street to conduct a drop off for a product or a drop off of a child from a bus for the child's actual destination. The wrong side of the road here means that the side of the road along which a relevant vehicle door requires a person to cross the road to arrive at their intended destination. More simply, for example, a child may be dropped off from a bus and then have to cross the street to arrive at home, in this scenario, which is the child's actual destination. Interface 200 does not account for dropping a child off on the side of the street consistent with the child's destination, which is to say the child is dropped off across the street from, for example, the child's home. Such a situation is dangerous and puts both drivers and children at risk while crossing the road. Interface 200 illustrates the shortest path from point 215 to destination 225 without considering which side of the road the drop off will occur.

Interface 200 further includes an estimated time to arrival indicator 230 and a distance to arrival indicator 235. Interface 200 may further include an estimated time of arrival indicator 240. In this manner, a driver may be able to ascertain from interface 200 that from point 215, destination 225 may be reached in 3 minutes over a distance of 0.7 miles and that the vehicle may arrive by 8:59 PM.

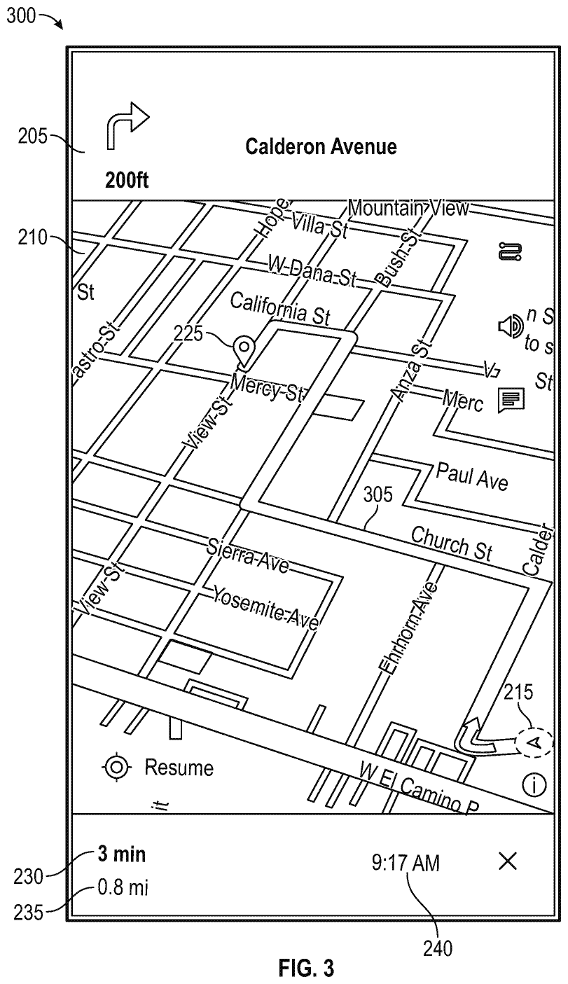

FIG. 3 illustrates an exemplary user interface 300 for a curbside pickup or drop off in fleet routing system 100. Interface 300 may be similar in some respects to interface 200, including turn by turn routing interface 205, map 210, starting point 215, destination 225, estimated time to arrival indicator 230, distance to arrival indicator 235, and estimated time of arrival indicator 240.

Route 305, however, has been significantly changed between point 215 and destination 225 from route 220, shown in FIG. 2 to accommodate curbside routing. For example, a driver at point 215 may turn right onto Calderon Avenue and proceed to Church Street. At Church Street, a driver may turn left and proceed along Church Street to Bush Street. At Bush street, the driver may turn right and proceed to California Street, bypassing Mercy Street. At California Street, the driver may turn left and proceed along California Street to View Street. The driver may turn left onto View Street and proceed to destination 225 on View Street. In this case, the passenger door opens to a curb on the side of the street on which the child being dropped off lives, which prevents the child from having to cross the street to arrive home. It should be noted that a driver delivering goods, for example, may also use similar techniques to arrive at destination 225 on the side of the street that does not cause the driver to cross the street. It is also noted that no perceptible time difference has been identified between traveling 0.8 miles as shown in indicators 230 and 235 in FIG. 3. This illustrates that a short routing change lengthened route 305 in a minor fashion in terms of time and distance but at significantly increased safety to the driver or passengers on a vehicle traversing route 305. Finally, with respect to FIG. 3, it is also noted that route 305 does not allow for U-turns, which are difficult in large delivery and passenger vehicles, while fleet routing system 100 enforces a “safe side” drop off to prevent a driver or child from crossing a street, as will be discussed in more detail below.

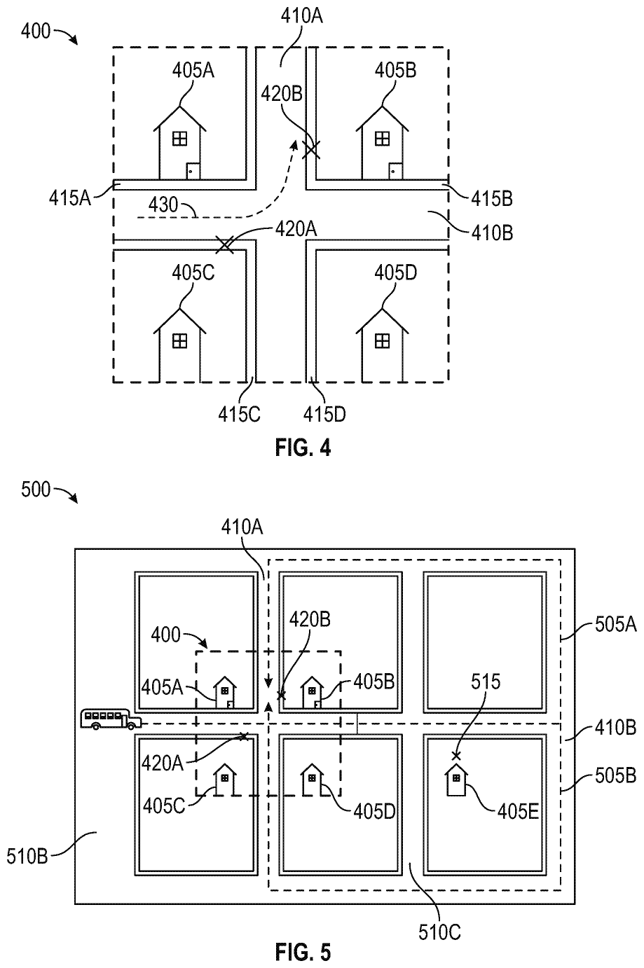

FIG. 4 illustrates an exemplary schematic implementation of an intersection 400 of curbside routing in fleet routing system 100. For example, FIG. 4 illustrates intersection 400 of roads 410A and 410B which have houses 405A, 405B, 405C, and 405D on one of each corner of the intersection of roads 410A and 410B. As shown, each corner includes a sidewalk 415A, 415B, 415C, and 415D which serves as a curb in front of each one of houses 405A-405D, respectively. Intersection 400 provides a stop 420A which is at house 405C and a stop 420B at house 405B. Stop 420A is on a right side of road 410B and second stop 420B is on a right side of road 410A, while following vehicle path 430. As shown in FIG. 4, as a simple schematic example, a vehicle, such as a bus, may execute a drop off of a child at stop 420A at curb 415C in front of the child's house 405C without causing the child to cross the street. Following vehicle path 430, the vehicle may turn left onto road 410A and stop at second stop 420B. The vehicle may execute a drop off at second stop 420B at curb 415B in front of the child's house 405B in a manner that prevents a child from crossing the street (e.g., prevents a street crossing condition). FIG. 4 illustrates a simple ideal case for routing a vehicle in fleet routing system 100. The driver may be provided by fleet routing system 100 via driver device 100 with turn by turn instructions which provide a driving route optimized to minimize time spent on the road while also providing a curbside pickup or drop off, as will be further discussed below. Simply put, fleet routing system 100 may route vehicles in a fashion that optimizes for the side of the street that is the same as the child's intended destination while also optimizing for spending as little time on the road as possible to accomplish each required drop off.

FIG. 5 illustrates another embodiment of an exemplary schematic 500 implementation of curbside routing in fleet routing system 100. Schematic 500 includes a wider map than shown in intersection 400, shown in FIG. 4. For example, schematic 500 illustrates a plurality of roads 410A, 410B, 510A, 510B, 510C, and 510B and includes intersection 400, as shown in FIG. 5. FIG. 5 illustrates a slightly more complicated routing issue for curbside routing. In addition to stops 420A and 420B, a third stop 515 is created for a student who lives in house 405E, which is also on the same side of road 410B as houses 405C and 405D. If a driver is traveling from left to right on road 410B, fleet routing system has a plurality of options to perform curbside routing. One optional route 505A, is shown which fails to provide curbside routing and should be rejected (which is discussed for exemplary purposes) while route 505B is determined to be an optimized route for curbside routing.

In route 505A, a driver may be proceeding from left to right on road 410B and may drop off a child, for example, from a bus at stop 420A on a curb 415C, shown in FIG. 4. The bus may proceed to stop 515 along route 505A and drop off a child from a bus at stop 515 at a curb in front of house 405E, where the child lives. Stop 515 on route 505A may also be considered a curbside drop off. After stop 515, a driver may continue to road 510D and turn towards road 510A along road 510D. At road 510A, the driver may turn left onto road 510A and proceed to road 410A where the driver will again turn left. The driver may proceed down road 410A and reach stop 420B, but due to non-curbside routing, find that the bus door opens to house 405A instead of house 405B, where the intended destination for the child is located. Stop 420B becomes a non-safe side drop off location because a child would have to cross road 410A to arrive at the child's intended destination at house 405B. Route 505A creates a dangerous condition for the child that can be ameliorated by route 505B.

Route 505B may begin with a driver proceeding from left to right on road 410B and may drop off a child, for example, from a bus at stop 420A on a curb 415C, shown in FIG. 4. The bus may proceed to stop 515 along route 505A and drop off a child from a bus at stop 515 at a curb in front of house 405E, where the child lives. Stop 515 on route 505A may also be considered a curbside drop off. After stop 515, a driver may continue to road 510D and turn towards road 510B along road 510D. At road 510B, the driver may turn right onto road 510B and proceed to road 410A where the driver may again turn right onto road 410A. The driver may proceed down road 410A to stop 420B. At stop 420B, by following route 505B, the vehicle is oriented such that the door on the vehicle, such as a bus, opens to curb 415B, as shown in FIG. 4, to allow a child to disembark from the bus at the child's home 405B, without crossing the street. Other potential routes are possible to still provide curbside routing. Route 505B is not meant to be exhaustive of all potential routes, only explanatory of an embodiment of curbside routing that incorporates three stops. In implementation, multiple stops may be necessary to drop off each child on a bus to the child's home. However, fleet routing system 100 may use server 130 to identify which children are on a bus (or goods on a delivery vehicle, for example) identify the order of the stops for each child and the side of the street each child's house is on to identify stops to drop off each child. From there, fleet routing system 100 may optimize the order of the stops for curbside routing using curbside routing techniques.

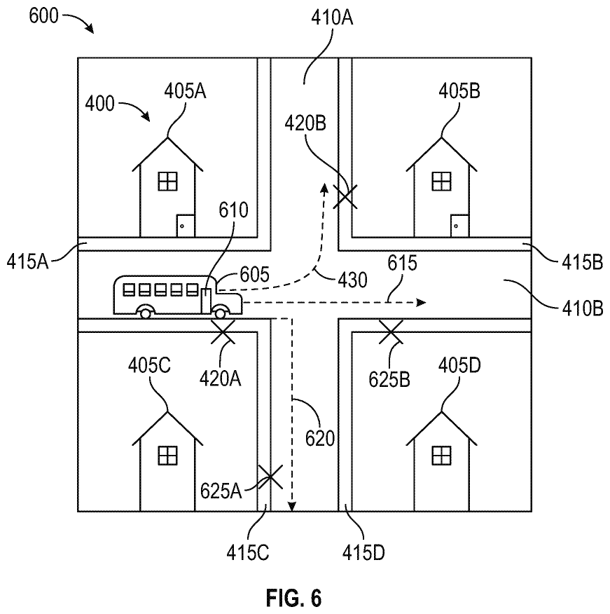

FIG. 6 illustrates a schematic 600 embodiment of optimizing routes based on an optimized stop order for a fleet routing system 100. Schematic 600 may incorporate intersection 400 shown in FIG. 4. For example, FIG. 4 illustrates intersection 400 of roads 410A and 410B which have houses 405A, 405B, 405C, and 405D on one of each corner of the intersection of roads 410A and 410B. As shown, each corner includes a sidewalk 415A, 415B, 415C, and 415D which serves as a curb in front of each one of houses 405A-405D, respectively. Intersection 400 provides a first stop 420A which is at house 405C and a second stop 420B at house 405B. First stop 420S is on a right side of road 410B and second stop 420B is on a right side of road 410A, while following vehicle path 430.

As shown in FIG. 6, a bus 605 includes a passenger door 610. Bus 605 may have three paths for proceeding to a next stop. For example, path 430 may provide curbside routing for stop 420B. Path 615 may provide curbside routing for stop 615B. Path 620 may provide curbside routing for stop 615A. Fleet routing system 100 may rely on server device 135 to generate optimized routing and select one of paths 430, 615, and 620 to provide optimized curbside routing for each stop assigned to a vehicle on a route. For example, server device 135 may determine an optimized route for curbside routing to minimize both the amount of time the vehicle is servicing the route and while identifying curbside stops which position door 610 of bus 605 adjacent to a curb where an identified stop is scheduled.

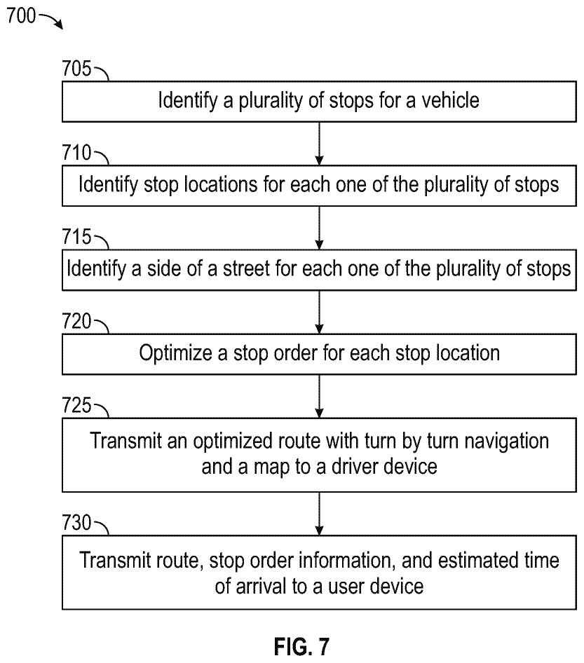

FIG. 7 illustrates a method 700 of optimizing routes based on an optimized stop order for curbside routing in a fleet routing system 100. Method 700 begins at step 705 where a device, such as server device 135, identifies a plurality of stops for a vehicle. The stops for the vehicle may include drop off points for children from a bus or may include a delivery for a particular good, for example. Typically, the stop locations may be identified as addresses, which may be associated with the stop, a child's home address, or a service delivery address, for example. At step 705, for example, a plurality of children may be served by a school bus. Fleet routing system 100 may determine, based on server device 135, addresses for each child assigned to a particular route for a particular bus. Server device 135 may then identify suitable stop locations for each one of the plurality of stops 710. For example, server device 135 may identify addresses for each one of the plurality of stops, or each one of the children, for example, on the bus. Based on the stop location information, the server device 135 may identify a side of the street for each one of the plurality of stops at step 715.

Server device 135 may overlay an identified stop location for each one of the plurality of stops on a map to determine which side of a street the stop location should be positioned on to prevent a driver or passenger from crossing a street to arrive at the intended destination. Alternatively, server device 135 may identify, based on address number (e.g., odd, or even) which side of the street a child's house, for example, is located as the intended destination for the child. Server device 135 may use any technological means, including manual input, to locate a side of the street as stop location for a particular stop. Once the stop locations and the side of the street for each stop location is identified in steps 705-715, server device 135 may optimize a stop order for each stop location at step 720. In other words, server device may perform curbside routing to identify a stop order based on the most efficient route to service each stop location on the identified side of the street. The optimization of step 720 may optimize based on both the stop location on the identified side of the street and based on determining a fastest route for servicing each stop location on the identified side of the street. Optimizing in step 720 may include using an artificial intelligence engine operated by server device 135, using machine learning techniques.

At step 725, server device 135 may transmit an optimized route for curbside routing with turn by turn navigation and a map to a driver device to provide the driver, via driver device 120, for example, with the optimized route information with the optimized stop order for each stop based on curbside routing. Server device 135 may further transmit route, stop order information, and estimated time of arrival for a particular stop to a user device at step 730. In this manner, a parent using user device 115, for example, may receive a real time indication of where a bus is located and when the bus is likely to arrive to drop off a child. At step 730, method 700 is terminated.

The foregoing description has been presented for the purposes of illustration and description. It is not intended to be exhaustive or to limit the disclosure to the precise form disclosed. Many modifications and variations are possible in light of the above disclosure and teachings. Further, it should be noted that any or all of the aforementioned alternate implementations may be used in any combination desired to form additional hybrid implementations of the disclosure. For example, components described herein may be removed and other components added without departing from the scope or spirit of the embodiments disclosed herein or the appended claims.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

1. A system, comprising:
a server device comprising one or more processors and a memory storing instructions that, when executed by the one or more processors, cause the one or more processors to perform steps including:
identifying a plurality of stops for a vehicle among a fleet of vehicles, wherein each stop corresponds to an address for a passenger of the vehicle;
identifying a plurality of stop locations for each one of the plurality of stops;
identifying a side of a street for each one of the plurality of stop locations based on an address number of the address associated with the stop location to prevent a passenger from crossing a street between the vehicle and the address;
performing curbside routing to identify a stop order to service each stop location on the identified side of the street that prevents each passenger from crossing the street between the vehicle and the address, wherein the stop order is identified based on at least information previously received from one or more driver devices associated with the fleet of vehicles, wherein the information previously received from the one or more driver devices comprises information about a stop location identified by the server device for a particular stop versus where the particular stop actually occurred;
generating a route to service each one of the plurality of stops according to the stop order for the plurality of stops;
transmitting the route with turn by turn navigation instructions for the route and a map of the route to a driver device associated with the vehicle; and
transmitting the stop order for the route and time of arrival of the vehicle at a particular one of the plurality of stop locations to a user device associated with the particular one of the plurality of stop locations.

2. The system of claim 1, wherein the vehicle for which the plurality of stops is identified is a bus.

3. The system of claim 2, wherein the one of the plurality of stop locations identified by the server device is a house address for a rider of the bus.

4. The system of claim 3, wherein each stop location of the stop locations of the bus is selected to drop the rider of the bus off on the same side of the street as the house address.

5. (canceled)

6. The system of claim 1, wherein the curbside routing provides service to the side of the street on which a destination is located.

7. The system of claim 6, wherein the curbside routing selects a route along which a door of the vehicle opens to a side of the street on which the destination is located.

8. The system of claim 1, wherein the route is generated without U-turns on a single road.

9. (canceled)

10. The system of claim 1, wherein server device further transmits real time location status to the user device.

11. A method, comprising:
identifying, by a server device, a plurality of stops for a vehicle among a fleet of vehicles, wherein each stop corresponds to an address for a passenger of the vehicle;
identifying, by the server device, a plurality of stop locations for each one of the plurality of stops;
identifying, by the server device, a side of a street for each one of the plurality of stop locations based on an address number of the address associated with the stop location to prevent a passenger from crossing a street between the vehicle and the address;
performing, by the server device, curbside routing to identify a stop order to service each stop location on the identified side of the street that prevents each passenger from crossing the street between the vehicle and the address, wherein the stop order is identified based on at least information previously received from one or more driver devices associated with the fleet of vehicles, wherein the information previously received from the one or more driver devices comprises information about a stop location identified by the server device for a particular stop versus where the particular stop actually occurred;
generating, by the server device to service each one of the plurality of stops according to the stop order for the plurality of stops;
transmitting, by the server device, the route with turn by turn navigation instructions for the route and a map of the route to a driver device associated with the vehicle; and
transmitting, by the server device, the stop order for the route and time of arrival of the vehicle at a particular one of the plurality of stop locations to a user device associated with the particular one of the plurality of stop locations.

12. The method of claim 11, wherein the vehicle for which the plurality of stops is identified is a bus.

13. The method of claim 12, wherein the stop location is a house address for a rider of the bus.

14. The method of claim 13, wherein each stop location of the stop locations of the bus is selected to drop the rider of the bus off on the same side of the street as the house address.

15. (canceled)

16. The method of claim 11, wherein the curbside routing provides service to the side of the street on which a destination is located.

17. The method of claim 16, wherein the curbside routing selects a route along which a door of the vehicle opens to a side of the street on which the destination is located.

18. The method of claim 11, wherein the route is generated without U-turns on a single road.

19. (canceled)

20. The method of claim 11, wherein server device further transmits real time location status to the user device.
